(19) United States
(12) Patent Application Publication
(10) Pub. No.: US 2023/0177547 A1
(43) Pub. Date: Jun. 8, 2023

(54) Vehicle and Method for Applying Code for an Electronic Toll Collection System

(71) Applicants: Hyundai Motor Company, Seoul (KR); Kia Corporation, Seoul (KR)

(72) Inventor: Seung Jae Lee, Gwangmyeong-si (KR)

(21) Appl. No.: 17/950,337

(22) Filed: Sep. 22, 2022

(30) Foreign Application Priority Data
Dec. 8, 2021 (KR) 10-2021-0174775

(51) Int. Cl. G06Q 30/02; G07B 15/06

(52) U.S. Cl. CPC G06Q 30/0207; G07B 15/063

(57) ABSTRACT

An embodiment method of applying a code for an electronic toll collection system (ETCS) includes searching, by a connected car service (CCS) server, a vehicle registration server for registration information about a vehicle in response to an external request and transmitting, by the CCS server to the vehicle, a discount code for the ETCS based on a result of the searching so that the vehicle can apply the discount code to an ETCS terminal.

### CROSS-REFERENCE TO RELATED APPLICATIONS

This application claims the benefit of Korean Patent Application No. 10-2021-0174775, filed on Dec. 8, 2021, which application is hereby incorporated herein by reference.

### TECHNICAL FIELD

The present disclosure relates to a vehicle and a method for applying a code for an electronic toll collection system.

### BACKGROUND

The term “an electronic toll collection system (ETCS)” refers to a system configured to automatically collect tolls such as a passage toll and a congestion toll from vehicles that pass toll roads, bridges, or the like generally using an automatic vehicle identification (AVI) technology.

The ETCS allows a vehicle to pay a toll at a time at which the vehicle passes through wireless communication between a vehicle-side terminal provided in the vehicle and a tollgate-side terminal installed around a road, thereby reducing required human labor while reducing traffic congestion, in comparison to a manual toll collection method.

Recently released vehicles have such a vehicle-side terminal embedded therein as factory default and may thus use the ETCS immediately after a card for paying tolls is inserted in a slot of the terminal after a predetermined initial terminal opening process.

The ETCS may apply various toll discounts including, for example, a personal discount associated with an owner or passenger of a vehicle, a vehicle type discount associated with a type of a power source or a purpose of driving, a timeslot discount associated with a tollgate passage timeslot, or the like. Among these, the timeslot discount may be set by a system operator that collects tolls such that a toll is automatically applied based on a timeslot, whereas the personal discount or the vehicle type discount may be generally implemented by recording a discount code in a vehicle-side terminal.

Table 1 below and Table 2, which is provided in FIG. 4, illustrate an example of a personal discount code and an example of a vehicle type discount code, respectively.

TABLE 1

| Classification | Details | Band |
|---|---|---|
| 0 × 00~0 × 0F | General | 0 × 00~0 × 0F |
| 0 × 11~0 × 16 | Disabled persons with 1st to 6th grades of disabilities | 0 × 10~0 × 1F |
| | (50%) | |
| 0 × 21~0 × 25 | Wounded persons of national merit in 1st to 5th grades | 0 × 20~0 × 2F |
| | (100%) | |
| 0 × 36~0 × 37 | Wounded persons of national merit in 6th and 7th grades | 0 × 30~0 × 3F |
| | (50%) | |
| 0 × 41~0 × 45 | Persons wounded in the May 18 Democratization | 0 × 40~0 × 4F |
| | Movement in 1st to 5th grades (100%) | |
| 0 × 56~0 × 5E | Persons wounded in the May 18 Democratization | 0 × 50~0 × 5F |
| | Movement in 6th or lower grades (50%) | |
| 0 × 61 | ‘61’ persons of distinguished service to independence | 0 × 60~0 × 6F |
| | (100%) | |
| 0 × 71 | ‘71’ patients suffering from actual or potential aftereffects | 0 × 70~0 × 7F |
| | of defoliants (50%) | |
| 0 × 81~0 × 84 | Trucks over 4.5 tons (commercial): 0 × 81 | 0 × 80~0 × 8F |
| | Trucks over 4.5 tons (non-commercial): 0 × 82 | |
| | Trucks under 4.5 tons (commercial): 0 × 83 | |
| | Trucks under 4.5 tons (non-commercial): 0 × 84 | |
| 0 × −90~0 × FF | (Not used) | 0 × 90~0 × FF |

Currently, to record the foregoing discount codes in vehicle-side terminals of individual vehicles, direct visits may need to be made to a sales and service office of an entity operating the ETCS. Specifically, the sales and service office may verify whether the personal discount or the vehicle type discount is applicable based on a result of searching a vehicle registration server, and insert, into a vehicle-side terminal, a card held by the office in which discount codes corresponding to verified reasons for discounts are recorded or allow the vehicle-side terminal to recognize the card more than once. In this way, the discount codes may be recorded in the vehicle-side terminal. Only after the discount codes are recorded in the vehicle-side terminal, an applicable discount code may be transmitted to the vehicle-side terminal at a time of a toll payment to be made at a tollgate-side terminal in the passage of a tollgate, and a discount corresponding to the transmitted code may then be received.

Thus, even when the vehicle-side terminal is opened to use and has a card for paying the toll, there may be an inconvenience because a discount code is applicable only after the direct visit to the sales and service office of the entity operating the ETCS.

### SUMMARY

The present disclosure relates to a vehicle and a method for applying a code for an electronic toll collection system. Particular embodiments relate to a vehicle capable of automatically applying a code such as a discount code to a vehicle-side terminal of an ETCS and a code applying method thereof.

An embodiment of the present disclosure provides a vehicle capable of more conveniently applying a code for an ETCS and a code applying method thereof.

However, technical features of embodiments of the present disclosure are not limited to the foregoing features, and other technical features may also be present. Additional features of embodiments of the disclosure will be set forth in part in the description which follows and, in part, will be apparent from the description, or may be learned by practice of the presented embodiments of the disclosure.

According to an example embodiment, there is provided a method of applying a code for an ETCS. The method may include searching, by a connected car service (CCS) server, a vehicle registration server for registration information about a vehicle in response to an external request, transmitting, by the CCS server to the vehicle, a discount code for the ETCS based on a result of the searching, and applying, by the vehicle, the transmitted discount code to an ETCS terminal.

For example, when there are two or more discount codes applicable to the vehicle as a result of the searching, the CCS server may transmit, to the vehicle, a discount code having a highest discount rate among the discount codes.

For example, when there are two or more discount codes applicable to the vehicle as a result of the searching, the CCS server may transmit, to the vehicle, a discount code corresponding to a selection by a user through an external terminal among the discount codes.

For example, the transmitting may include transmitting, by the CCS server, the discount code to a head unit of the vehicle.

For example, the applying may include transmitting, by the head unit, the transmitted discount code to the ETCS terminal.

For example, the method may further include transmitting, by a controller, a vehicle type discount code or vehicle type discount information to the ETCS terminal when there is no applied discount code.

For example, when the vehicle type discount information is transmitted, the method may further include outputting, by the ETCS terminal, a guide on whether a vehicle type discount is available.

For example, the transmitting may comprise transmitting the vehicle type discount code when the same vehicle type discount code is applicable for each registration region.

For example, when a different vehicle type discount code is applicable for each registration region, the vehicle type discount code stored in the controller is not applied.

A computer readable medium according to an embodiment of the present invention may store a computer program which is configured to control a processor to perform one of the above methods.

According to another example embodiment, there is provided a system for applying a code for an ETCS. The system may include a CCS server and a vehicle including an ETCS terminal. The CCS server may search a vehicle registration server for registration information about the vehicle in response to an external request and transmit, to the vehicle, a discount code for the ETCS based on a result of the searching, and the vehicle may apply the transmitted discount code to the ETCS terminal.

For example, when there are two or more discount codes applicable to the vehicle as a result of the searching, the CCS server may transmit, to the vehicle, a discount code having a highest discount rate among the discount codes.

For example, when there are two or more discount codes applicable to the vehicle as the result of the searching, the CCS server may transmit, to the vehicle, a discount code corresponding to a selection by a user through an external terminal among the discount codes.

For example, the CCS server may transmit the discount code to a head unit of the vehicle.

For example, the head unit may transmit the transmitted discount code to the ETCS terminal.

For example, the vehicle may control a controller to transmit a vehicle type discount code or vehicle type discount information to the ETCS terminal when there is no applied discount code.

For example, when the vehicle type discount information is transmitted, the ETCS terminal may output a guide on whether a vehicle type discount is available.

For example, when the same vehicle type discount code is applicable for each registration region, the vehicle type discount code is transmitted from the controller to the ETCS terminal.

For example, when a different vehicle type discount code is applicable for each registration region, the vehicle type discount code stored in the controller is not applied.

According to example embodiments described herein, a code for an ETCS may be conveniently applied without a visit to a sales and service office.

Additional advantages, objects, and features of embodiments of the present disclosure will be set forth in part in the description which follows and in part will become apparent to those having ordinary skill in the art upon examination of the following or may be learned from practice of the disclosure. The objects and other advantages of embodiments of the disclosure may be realized and attained by the structure particularly pointed out in the written description and claims hereof as well as the appended drawings.

### BRIEF DESCRIPTION OF THE DRAWINGS

FIG. 1 is a diagram illustrating an example configuration of an electronic toll collection system (ETCS) for automatic code application according to example embodiments of the present disclosure.

FIG. 2 is a diagram illustrating an example of an automatic code application process according to an example embodiment of the present disclosure.

FIG. 3 is a diagram illustrating another example of an automatic code application process according to an example embodiment of the present disclosure.

FIG. 4 is a table referred to below as Table 2.

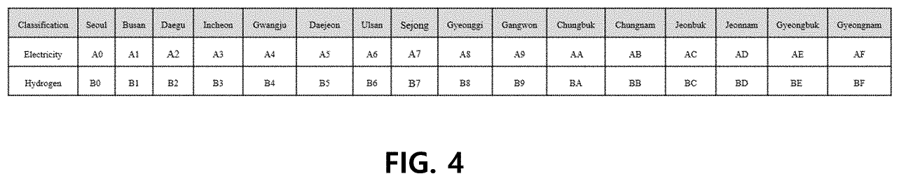

### DETAILED DESCRIPTION OF ILLUSTRATIVE EMBODIMENTS

Hereinafter, example embodiments of the present disclosure will be described in detail with reference to the accompanying drawings, and the same or similar elements will be given the same reference numerals regardless of reference symbols, and redundant description thereof will be omitted. In the following description, the terms “module” and “unit” for referring to elements are assigned and used interchangeably in consideration of convenience of explanation, and thus the terms per se do not necessarily have different meanings or functions. Further, in describing the embodiments disclosed in the present specification, when it is determined that a detailed description of related publicly known technology may obscure the gist of the embodiments disclosed in the present specification, the detailed description thereof will be omitted. The accompanying drawings are used to help easily explain various technical features, and it should be understood that embodiments presented herein are not limited by the accompanying drawings. As such, embodiments of the present disclosure should be construed to extend to any alterations, equivalents and substitutes in addition to those which are particularly set out in the accompanying drawings.

Although terms including ordinal numbers, such as “first,” “second,” etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, pails, or combinations thereof described in the specification are present, and does not preclude the possibility of addition or presence of one or more other features, numbers, steps, operations, elements, parts, or combinations thereof.

According to example embodiments described herein, there is provided a vehicle capable of automatically applying a discount code without a direct visit of a vehicle to a sales and service office of an entity operating an electronic toll collection system (ETCS), and a code applying method thereof.

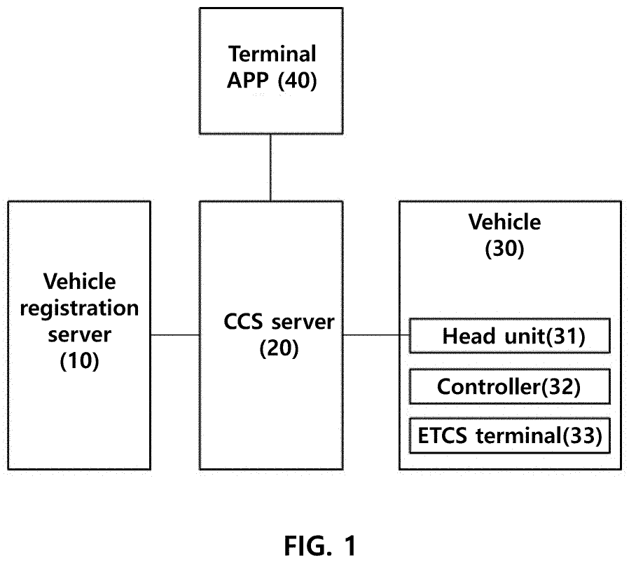

Hereinafter, a configuration of an ETCS applicable to example embodiments described herein will be first described with reference to FIG. 1.

FIG. 1 is a diagram illustrating an example configuration of an ETCS for automatic code application according to example embodiments of the present disclosure.

Referring to FIG. 1, an ETCS may include a vehicle registration server 10, a connected car service (CCS) server 20, a vehicle 3o, and a terminal application (app) 40.

The vehicle registration server 10, which refers to a public server of a public office that manages vehicle registration information, may register and manage license plates, vehicle identification numbers, vehicle owner information, and other vehicle information in combination, for initial registration of new vehicles, registration of transfer of used vehicles, or the like. Thus, information (e.g., the purpose of use, power source, registration region, whether a vehicle owner is a disabled person, a person of merit, or the like, etc.) for determining a discount code applicable to each vehicle may be stored in the vehicle registration server 10.

The CCS server 20 may perform wired or wireless communication with a head unit 31 of the vehicle 30, the vehicle registration server 10, and the terminal app 40.

The vehicle 30 may include the head unit 31, various controllers 32, and an ETCS terminal 33, and the head unit 31 may exchange data with the controllers 32 and the ETCS terminal 33 through a predetermined vehicle communication protocol (e.g., controller area network (CAN)).

The terminal app 40 may be installed and operate on smart devices such as smartphones.

The CCS server 20, the head unit 31, and the terminal app 40 may be linked to each other through a single account (e.g., a CCS account). In this case, a user may log into the CCS server 20 with a corresponding account on a webpage provided by a CCS application or the CCS server 20 to the terminal application 40 or linked to the CCS server 20. The user may thus allow a command for controlling various functions of the vehicle 30 to be transmitted from the CCS server 20 to the head unit 31, or allow the CCS server 20 to search the vehicle registration server 10 for information and receive a result of the searching.

The controllers 32 may be desirable to be configured to store or hold therein a vehicle type discount code associated with a vehicle type from the time of manufacture. The vehicle type discount code may be a discount code associated with a type of a driving source such as shown in an electric vehicle or hydrogen-fueled vehicle, and may be more desirably stored or held in a controller provided only in a vehicle having a specific driving source. For example, discount codes may be stored in a vehicle control unit (VCU) for an electric vehicle and in a fuel-cell control unit (FCU) for a hydrogen-fueled vehicle, but examples are not limited thereto. The controllers 32 may transmit a discount code to the ETCS terminal 33 in response to a determination made by themselves or a request from the ETCS terminal 33.

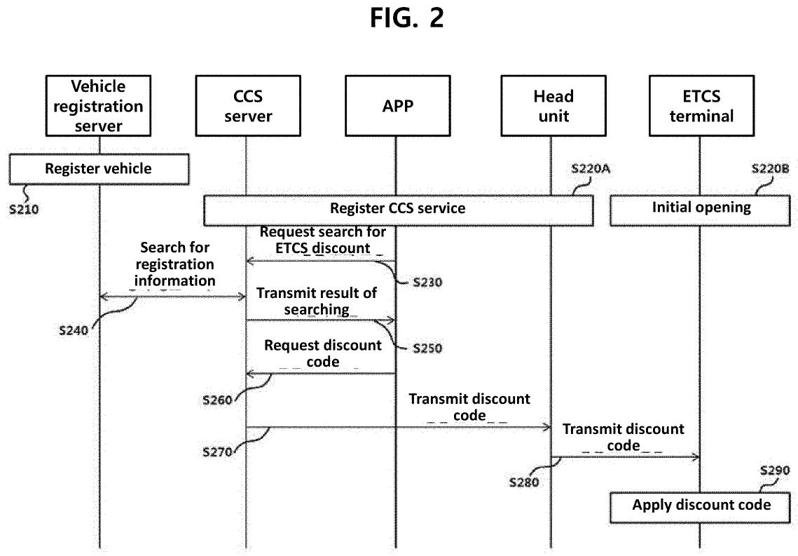

FIG. 2 is a diagram illustrating an example of an automatic code application process according to an example embodiment of the present disclosure.

Referring to FIG. 2, in step S210, a vehicle registration procedure may be performed in a vehicle registration server. For example, in response to the purchase of a new vehicle or acquisition of a used vehicle, information specifying discount codes, for example, vehicle owner information, a vehicle identification number, a license plate, and other vehicle information, may be input to the vehicle registration server.

In step S220A, a CCS registration procedure may be performed among a CCS server, a terminal app, and a head unit of a vehicle.

The CCS registration procedure may include an operation of opening a modem of the head unit and registering it in the CCS server in connection with unique identification information of the vehicle, and an operation of generating an account to be managed by the CCS server and linking vehicle information with the account. It is assumed hereinafter that, in the procedure including these operations, the terminal app may perform data exchange with the CCS server based on a communication function of a portable terminal in which the terminal app is installed and operated. The procedure may also be performed through a general web browser instead of the terminal app.

In step S220B, an initial opening procedure may be performed on the ETCS terminal.

In a situation that is not related to the initial registration of a new vehicle, at least one of steps S210, S220A, and S220B may be already performed, and thus the corresponding step may be omitted.

In step S230, when steps S210, S220A, and S220B are all completed, a user may request the CCS server for searching for an ETCS discount code through the terminal app.

The CCS server may then search the vehicle registration server for registration information about the vehicle linked to the account in step S240, and transmit a result of the searching to the terminal app in step S250. In a communication process between the CCS server and the vehicle registration server, a predetermined security authentication procedure may be added.

In step S260, the user may verify the result of the searching and request an applicable discount code. In step S270, the CCS server may transmit the discount code to the head unit.

In general, there may be one code applicable to the ETCS terminal. Thus, when there is a plurality of applicable discount codes as a result of searching for the registration information, information about the applicable discount codes may be transmitted to the terminal app in step S250. In this case, information about a discount rate for each code may also be displayed through the terminal app, and the user may thus select a desired code from among the discount codes. Also, based on a determination made by the CCS server, a code having a highest discount rate among the discount codes may be transmitted in step S250.

In step S280, when obtaining the discount code by the head unit, the head unit may transmit the discount code to the ETCS terminal. In step S290, the ETCS terminal may apply the received discount code.

Through the process described above, a discount code may be wirelessly transmitted to a vehicle in a CCS process, and thus a user may apply the discount code without a direct visit to a sales and service office of an ETCS operator.

As described above with reference to FIG. 1, discount codes may be stored in the controllers 32. In this case, according to another example embodiment of the present disclosure, the discount codes may be transmitted from the controllers 32 to the ETCS terminal.

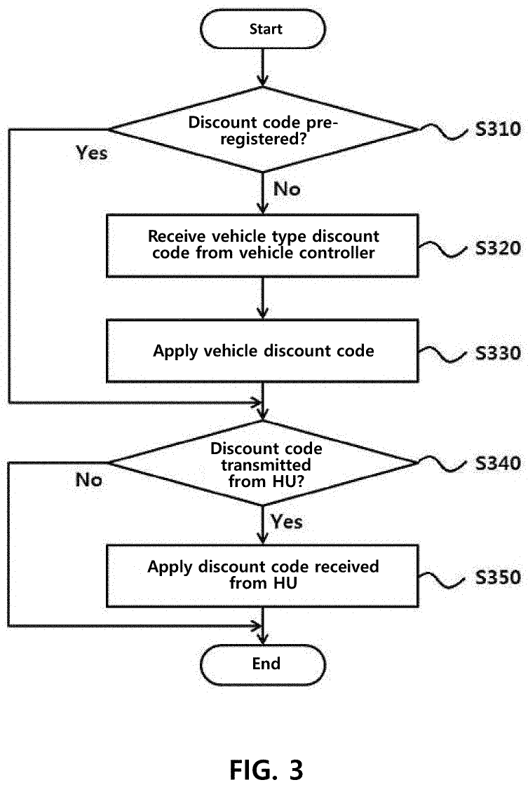

FIG. 3 is a diagram illustrating another example of an automatic code application process according to an example embodiment of the present disclosure.

Referring to FIG. 3, in step S310, when power is input to an ETCS terminal (e.g., the ETCS terminal 33) while power is being supplied to electronic parts of a vehicle, for example, a key box ignition (IG) on state, whether a discount code is pre-registered may be determined.

In step S320, when the discount code is not pre-registered (No in S310), a discount code corresponding to a vehicle type discount may be received by the ETCS terminal 33 from a vehicle controller 32 in which the discount code is stored. To this end, the ETCS terminal 33 may request the controller 32 for the discount code, and the controller 32 storing therein the discount code may determine whether there is a history of transmitting the discount code to the ETCS terminal 33, and transmit the discount code to the ETCS terminal 33 when there is no history of transmitting the discount code. Alternatively, a device such as a head unit (e.g., the head unit 31) may transmit a request command to the ETCS terminal 33 and the controller 32 to perform steps S310 and S320.

In step S330, when receiving the discount code, the ETCS terminal 33 may apply the received discount code.

However, when a discount rate of the vehicle type discount differs for each vehicle registration region according to regional or national policies, a registration region in which the vehicle is registered may not be known to the vehicle. Thus, when the discount code is not pre-registered (No in S310), the vehicle type discount code stored in the controller 32 may not be applied to the ETCS terminal 33, but step S340 may be immediately performed.

In step S350, when the discount code is pre-registered (Yes in S310 or after S330), the ETCS terminal 33 may apply again the discount code transmitted from the head unit 31 when the discount code is transmitted from the head unit 31 (Yes in S340). In contrast, when the discount code is not transmitted from the head unit 31 (No in S340), the discount code in S330 may be maintained.

The process described above with reference to FIG. 3 may be particularly convenient when there is no differential application of discount rates according to registration regions because there is no need to take processes through the CCS service. However, when the vehicle type discount code differs from one registration region to another, a vehicle type discount code of the lowest discount rate among vehicle type discount rates may be applied first until a discount code obtained through the CCS service is transmitted from the head unit 31. In addition, in a case where the vehicle type discount code is differentially applied with different discount rates according to registration regions, the controller 32 may transmit information indicating availability of a vehicle type discount or indicating a vehicle type to the ETCS terminal 33, instead of transmitting the vehicle type discount code to the ETCS terminal 33, and the ETCS terminal 33 may then output a guide indicating the availability of the vehicle type discount to allow the process described above with reference to FIG. 2 to be performed or to allow a user to visit a sales and service office.

On the other hand, embodiments of the present disclosure described above may be embodied as a computer-readable code on a medium in which a program is recorded. The computer-readable medium includes all types of recording devices in which data readable by a computer system is stored. Examples of the computer-readable medium include a hard disk drive (HDD), a solid-state drive (SSD), a silicon disk drive (SDD), a read-only memory (ROM), a random-access memory (RAM), a compact disc (CD)-ROM (CD-ROM), a magnetic tape, a floppy disk, an optical data storage device, etc. Therefore, the above detailed description should not be construed as restrictive and should be considered as illustrative in all respects. The scope of the present disclosure should be determined by a reasonable interpretation of the appended claims, and all modifications within the equivalent scope of the present disclosure are included in the scope of the present disclosure.

What is claimed is:

1. A method of applying a code for an electronic toll collection system (ETCS), the method comprising:
searching, by a connected car service (CCS) server, a vehicle registration server for registration information about a vehicle in response to an external request; and
transmitting, by the CCS server to the vehicle, a discount code for the ETCS based on a result of the searching so that the vehicle can apply the discount code to an ETCS terminal.

2. The method of claim 1, wherein, when there are two or more discount codes applicable to the vehicle as a result of the searching, the CCS server transmits, to the vehicle, a discount code having a highest discount rate among the discount codes.

3. The method of claim 1, wherein, when there are two or more discount codes applicable to the vehicle as a result of the searching, the CCS server transmits, to the vehicle, a discount code corresponding to a selection by a user through an external terminal among the discount codes.

4. The method of claim 1, wherein transmitting comprises transmitting, by the CCS server, the discount code to a head unit of the vehicle.

5. The method of claim 4, wherein a head unit of the vehicle applies the discount code to the ETCS terminal.

6. The method of claim 1, further comprising applying, by the vehicle, the discount code to the ETCS terminal.

7. The method of claim 6, further comprising transmitting, by a controller, a vehicle type discount code or vehicle type discount information to the ETCS terminal when there is no applied discount code.

8. The method of claim 7, further comprising outputting, by the ETCS terminal, a guide on whether a vehicle type discount is available, when the vehicle type discount information is transmitted.

9. The method of claim 7, wherein transmitting by the controller comprises transmitting the vehicle type discount code when the same vehicle type discount code is applicable for each registration region.

10. The method of claim 7, wherein, when a different vehicle type discount code is applicable for each registration region, the vehicle type discount code stored in the controller is not applied.

11. A non-transitory computer readable medium with a computer program recorded therein, the computer program being configured to control a processor to perform the method of claim 1.

12. A system for applying a code for an electronic toll collection system (ETCS), the system comprising:
a connected car service (CCS) server; and
a vehicle comprising an ETCS terminal;
wherein the CCS server is configured to search a vehicle registration server for registration information about the vehicle in response to an external request and to transmit, to the vehicle, a discount code for the ETCS based on a result of the search; and
wherein the vehicle is configured to apply the discount code to the ETCS terminal.

13. The system of claim 12, wherein when there are two or more discount codes applicable to the vehicle as a result of the search, the CCS server is configured to transmit to the vehicle a discount code having a highest discount rate among the discount codes.

14. The system of claim 12, wherein when there are two or more discount codes applicable to the vehicle as a result of the search, the CCS server is configured to transmit to the vehicle a discount code corresponding to a selection by a user through an external terminal among the discount codes.

15. The system of claim 12, wherein the CCS server is configured to transmit the discount code to a head unit of the vehicle.

16. The system of claim 15, wherein the head unit is configured to transmit the discount code to the ETCS terminal.

17. The system of claim 12, wherein when there is no applied discount code, the vehicle is configured to control a controller to transmit a vehicle type discount code or vehicle type discount information to the ETCS terminal.

18. The system of claim 17, wherein the ETCS terminal is configured to output a guide on whether a vehicle type discount is available when the vehicle type discount information is transmitted.

19. The system of claim 17, wherein, when the same vehicle type discount code is applicable for each registration region, the vehicle type discount code is transmitted from the controller to the ETCS terminal.

20. The system of claim 17, wherein, when a different vehicle type discount code is applicable for each registration region, the vehicle type discount code stored in the controller is not applied.
